(19) United States
(12) Patent Application Publication
(10) Pub. No.: US 2010/0058384 A1
(43) Pub. Date: Mar. 4, 2010

(54) SYSTEM AND METHODS FOR TELEVISION INTEGRATED SURROUND SOUND SYSTEMS

(76) Inventor: Peter Mortensen, Lake Elsinore, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/547,745

(22) Filed: Aug. 26, 2009

Related U.S. Application Data
(60) Provisional application No. 61/093,358, filed on Sep. 1, 2008.

(51) Int. Cl. H04N 5/445; H04R 5/02

(52) U.S. Cl. 725/38; 381/306

(57) ABSTRACT

Systems and methods for audio-video entertainment systems comprising a television and surround sound system integrating the television in the audio broadcast and/or the control of the surround sound system. More particularly, in one embodiment, an audio-video entertainment system includes a television and surround sound system incorporating the television speaker as the center channel speaker of the surround sound system. In another embodiment, the audio-video entertainment system includes a television driven surround sound system with the option of incorporating the television speaker as the center channel speaker of the surround sound system.

### CROSS-REFERENCE TO RELATED APPLICATION

This application claims the benefit of provisional application Ser. No. 61/093,358 filed Sep. 1, 2008, which is fully incorporated herein by reference.

### FIELD OF THE INVENTION

The invention relates generally to surround sound systems and more particularly to systems and methods that facilitate the integration of the television in the audio broadcast and system control.

### BACKGROUND INFORMATION

As the capabilities of the TV and other components increase and the video quality partly due to the introduction of HDTV is getting closer to the limitations of what our eyes can distinguish, more and more consumers will seek to match the experience of the HD video with a true surround sound experience. Surround sound generally refers to the application of multichannel audio to channels “surrounding” the audience in some combination of left surround, right surround, and rear surround as opposed to “screen channels” such as center, front left, and front right. In 4.0 channel or higher surround, the system will typically include a center channel speaker, a left front channel speaker and a right front channel speaker, two or more surround channel speakers in the rear or rear and side, and a low frequency effect channel to drive a subwoofer. For example, in 5.1 channel surround, the system typically includes a center channel speaker, a left front channel speaker and a right front channel speaker, two surround channel speakers in the left rear and right rear, and a low frequency effect channel to drive a subwoofer.

Typically, a consumer needs a high end audio-video receiver (AVR) in order to drive the sound system speakers. The AVR includes a decoder that will, depending on the audio source, extract from the audio signal a number channels corresponding to the number of available speakers or deliver a discrete number of audio channels corresponding to the available speakers. For example, in a 5.1 channel surround system, the decoder will, depending on the audio source, extract five audio channels and one LFE channel from either a specially encoded two-channel source or a stereo source and distribute to the five speakers and one sub-woofer or deliver five discrete audio channels and one LFE channel from a 6 channel source to the five speakers and one sub-woofer. However, for the consumer, the addition of an AVR component adds another level of complexity to their home entertainment system, the control of which can often be fraught with frustration.

Furthermore, since a television's own speaker or speakers are often in an optimum location, the addition of a separate center channel speaker for a surround sound system appears to add an unnecessary level of cost and complexity to the system.

Accordingly, it would be desirable to eliminate the need for a separate center channel speaker and/or a separate AVR component.

### SUMMARY

The embodiments provided herein are directed to systems and methods that facilitate the integration of audio-video receiver (AVR) type surround functionality with the television and with seamless system control of the surround sound functions. In one embodiment, an audio-video entertainment system comprises a television and a surround sound system incorporating the television speaker(s) as the center channel speaker. The surround sound system, which is depicted as a 5.1 channel system for exemplary purposes only, preferably includes an audio-video receiver (AVR) with the television coupled to the center channel output of the AVR, a sub-woofer coupled to the low frequency channel output of the AVR, left and right front speakers coupled to the left and right front channel outputs of the AVR and left and right rear surround speakers coupled to the left and right rear surround channel outputs. The television preferably comprises audio and video input connections and audio-video outputs such as audio speakers and a video display screen coupled to a control system. The control system resides in the TV and includes a control module comprising a central processing unit (CPU) and non-volatile memory upon which system control software is stored, an on screen display (OSD) controller coupled to the control module and the video signal input connections, an image display engine coupled to the OSD controller and the display screen. The control system further comprises a control interface to the AVR using IR, CEC (Consumer Electronics Control) or similar data communications protocol, an audio decoder-controller coupled to the control module, the audio input connections and the audio speakers. The audio input connections of the television preferably include conventional audio input connections and an audio center channel input connection to which the center channel output of the AVR can be connected.

In operation, the user using the menu system provided in the control system software can select “surround sound” or “television audio.” If “television audio” is selected, the control system software will instruct the internal television audio decoder/controller to decode and output the audio signal from the current selected audio source to the television speakers. If, however, “surround sound” is selected the control system software will instruct the internal television audio controller to output the audio signal from the audio center channel input connection to the television speakers. Furthermore the control system can instruct the AVR to power on.

In another embodiment, the audio-video entertainment system comprises a television and a surround sound system. The surround sound system preferably does not include an AVR, but rather the television is configured to drive the surround sound system. The television preferably comprises audio and video input connections, audio-video outputs such as audio speakers and a video display screen, and audio output connections coupled to a control system. As described above, the control system includes a control module comprising a central processing unit (CPU) and non-volatile memory upon which system control software is stored, an on screen display (OSD) controller coupled to the control module and the video signal input connections, an image display engine coupled to the OSD controller and the display screen. The control system further comprises an audio decoder-controller coupled to the control module, the audio input and output connections and the audio speakers. The audio input connections preferably include conventional audio input connections, while the audio output connections comprise left and right front, left and right rear surround, and low frequency effect channel output connections, and optionally a center channel output connection. The speakers of the surround sound system are preferably coupled to the audio output connections as follows: a sub-woofer coupled to the low frequency channel television output, left and right front speakers coupled to the left and right front channel television outputs and left and right rear surround speakers coupled to the left and right rear surround channel television outputs, and optionally an external center channel speaker.

Although the surround systems are described for exemplary purposes only as 5.1 systems, one of ordinary skill in the art would readily recognize the embodiments described herein to be adaptable to less complex system configurations as well as more complex or advanced system configurations such as, e.g., a 7.1 surround configuration or the like.

In operation, the user using the menu system provided in the control system software can select “surround sound” or “television audio.” If “television audio” is selected, the control system software will instruct the audio decoder/controller to decode and output the audio signal from the current selected audio source to the television speakers. If, however, “surround sound” is selected the control system software will instruct the audio decoder/controller to decode the audio signal from the current selected audio input source and output the audio channels to the appropriate audio output connection.

In another embodiment, the user can select whether a separate center channel speaker or the television speakers are utilized in surround sound mode.

In yet another embodiment, the television does not include a center channel output connection and directs center channel output to the television speakers when in surround sound mode.

In yet another embodiment, the surround sound system may include an audio power amplifier interposing the television and the sub-woofer and the left and right front, left and right rear surround, and center speakers.

In another alternative embodiment, preferred sound mode settings of “surround sound” or “television audio” can be saved to conform to different viewing experiences or activities. For example, activities such as “Watch News”, “Watch a Movie”, “Listen to Music”, “Play Game”, etc. Such viewing activities can be presented in a menu on the TV display screen or on a screen on the remote control unit and when selected, the control system software will instruct the audio decoder/controller to decode and output the audio signal from the current selected audio source to the speakers corresponding to the sound mode setting selected for viewing activity. If “television audio” is selected for the viewing activity, the control system software will instruct the audio decoder/controller to decode and output the audio signal from the current selected audio source to the television speakers. If, however, “surround sound” is selected for the viewing activity the control system software will instruct the audio decoder/controller to decode the audio signal from the current selected audio input source and output the audio channels to the appropriate audio output connection.

Other systems, methods, features and advantages of the invention will be or will become apparent to one with skill in the art upon examination of the following figures and detailed description.

### BRIEF DESCRIPTION OF THE FIGURES

The details of the invention, including fabrication, structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 depicts a schematic of a television and its control system.

FIG. 2 depicts a plan view of an audio-video entertainment system with a television and surround sound system incorporating the television speaker as the center channel speaker of the surround sound system.

FIG. 3 depicts a schematic of an alternate embodiment of a television and its control system.

FIG. 4 depicts a plan view of an alternate embodiment of an audio-video entertainment system with a television driven surround sound system.

FIG. 5 depicts a plan view of an alternate embodiment of an audio-video entertainment system with a television driven surround sound system incorporating the television speaker as the center channel speaker of the surround sound system.

FIGS. 6A and 6B depict schematics of a television screen showing an activity selection menu in a graphical user interface.

### DETAILED DESCRIPTION

The systems and methods described herein provide for audio-video entertainment systems comprising a television and surround sound system integrating the television in the audio broadcast and/or the control of the surround sound system. More particularly, in one embodiment the audio-video entertainment system includes a television and surround sound system incorporating the television speaker as the center channel speaker of the surround sound system. In another embodiment, the audio-video entertainment system includes a television driven surround sound system with the option of incorporating the television speaker as the center channel speaker of the surround sound system.

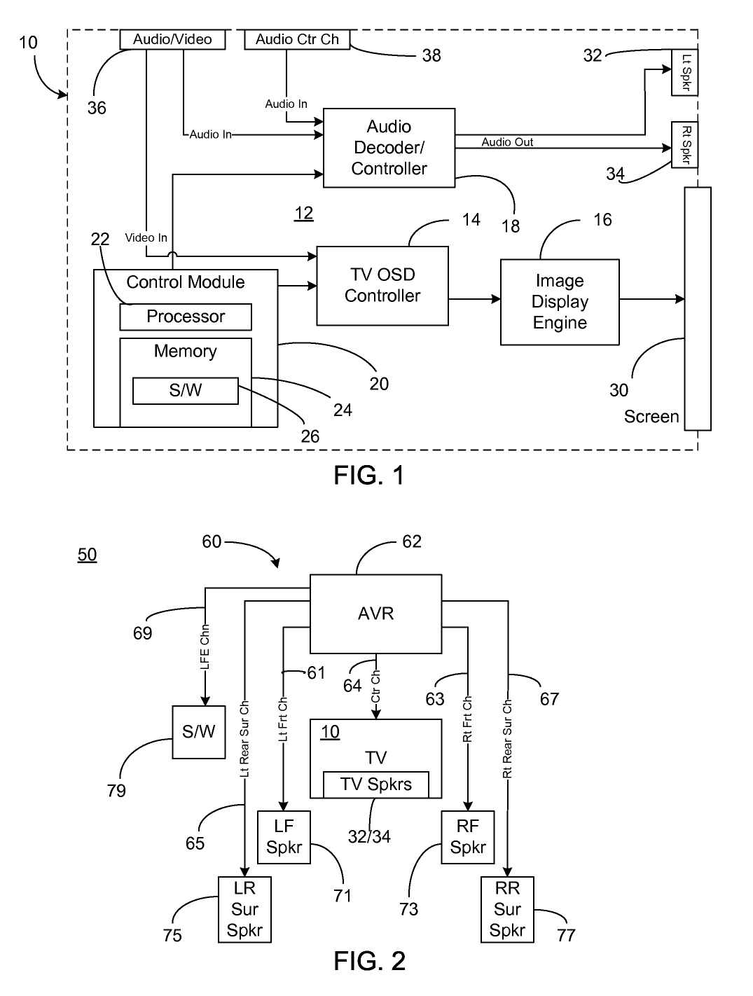

Turning in detail to the figures, FIG. 1 depicts a schematic of an embodiment of a television 10 incorporated in an audio-video entertainment system 50 shown in FIG. 2, which comprises a surround sound system 60 incorporating the television speaker(s) 32/34 as the center channel speaker. The surround sound system 60, which is depicted as a 5.1 channel system for exemplary purposes only and which one of ordinary skill in the art would readily recognize could comprise less complex system configurations as well as more complex or advanced system configurations such as, e.g., a 7.1 surround configuration or the like, preferably includes an audio-video receiver (AVR) 62 with the television 10 coupled to the center channel output 64 of the AVR 62, a sub-woofer 79 coupled to the low frequency channel output 69 of the AVR 62, left and right front speakers 71 and 73 coupled to the left and right front channel outputs 61 and 63 of the AVR 60 and left and right rear surround speakers 75 and 77 coupled to the left and right rear surround channel outputs 65 and 67. The television 10, as shown in FIG. 1, preferably comprises audio and video input connections 38 and 36 and audio-video outputs such as audio speakers 32 and 34 and a video display screen 30 coupled to a control system 12. The control system 12 preferably includes a control module 20 comprising a central processing unit (CPU) 22 and non-volatile memory 24 upon which system control software 26 is stored, an on screen display (OSD) controller 14 coupled to the control module 20 and the video signal input connections 36, an image display engine 16 coupled to the OSD controller 14 and the display screen 30.

A detailed discussion of a menu-based control system and graphical user interface is provided in U.S. Published Patent Application No. US 2002-0171624 A1, which is incorporated herein by reference. The '624 application describes the menu-based control system and its operation with regard to the centralized control of audio-video components coupled to a television and controlled using a menu-based control system with a graphical user interface.

The control system 20 further comprises a control interface to the AVR using IR, CEC (Consumer Electronics Control) or similar data communications protocol, an audio decoder-controller 18 coupled to the control module 20, the audio input connections 36 and 38 and the audio speakers 32 and 34. The audio input connections preferably include conventional audio input connections 36 and an audio center channel input connection 38 to which the center channel output 64 of the AVR 62 can be connected.

In operation, the user using a menu system provided in the control system software 26 can select available audio modes such as “television audio,” “2.0 stereo,” “3.1 stereo” or “surround sound” if the speakers for surround sound are connected to the audio outputs of the television. If “television audio” is selected, the control system software 26 will instruct the audio decoder/controller 18 to decode and output the audio signal from the current selected audio source input to the television speakers 32 and 34. If, however, “surround sound” is selected the control system software will instruct the audio decoder/controller to output the audio signal from the audio center channel input connection 38 to the television speakers 32 and 34. However, if, e.g., no left or right speakers are coupled to the left and right audio outputs of the television, the surround sound mode will utilize the television speakers 32 and 34. By measuring if a speaker is physically connected either through a switch in the connector itself or through measuring the impedance, it's possible to automate the setup process and ensure that only valid speaker modes are presented in the user interface.

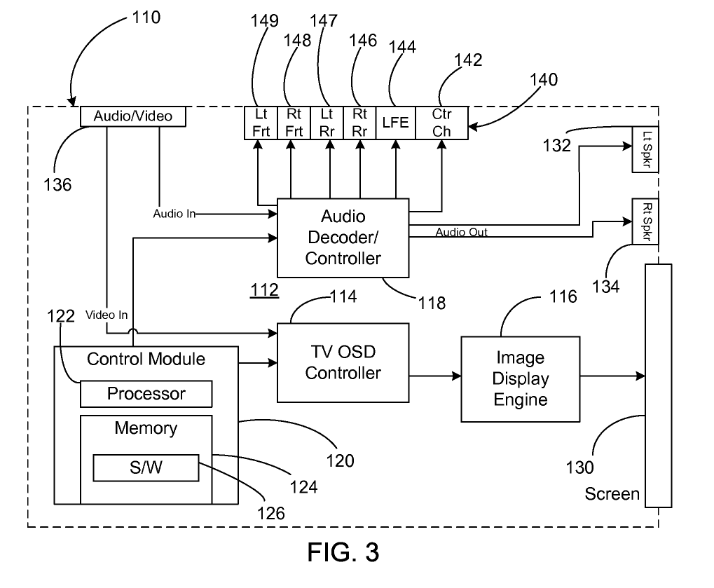

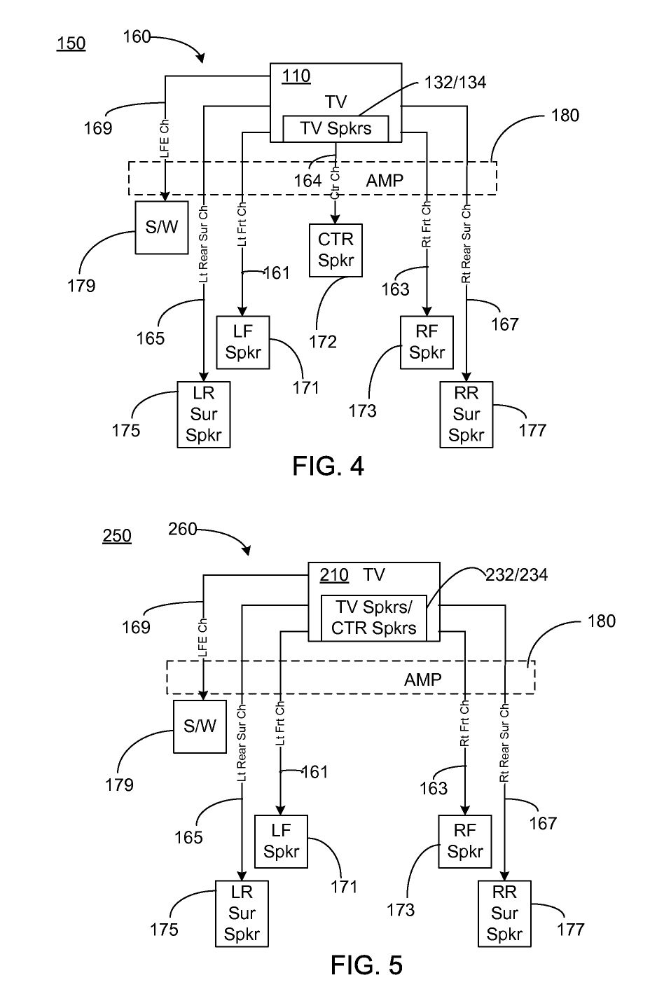

In another embodiment depicted in FIG. 4, the audio-video entertainment system 150 comprises a television 110 and a surround sound system 160. The surround sound system 160 preferably does not include an AVR, but rather the television 110 is configured to drive the surround sound system 160. The television 110, as depicted in FIG. 3, preferably comprises audio and video input connections 136, audio-video outputs such as audio speakers 132 and 134 and a video display screen 130, and audio output connections 140 coupled to a control system 112. As described above, the control system includes a control module 120 comprising a central processing unit (CPU) 122 and non-volatile memory 124 upon which system control software 126 is stored, an OSD controller 114 coupled to the control module 120 and the video signal input connections 136, an image display engine 116 coupled to the OSD controller 114 and the display screen 130. The control system 112 further comprises an audio decoder-controller 118 coupled to the control module 120, the audio input and output connections 136 and 140 and the audio speakers 132 and 134. The audio input connections 136 preferably include conventional audio input connections, while the audio output connections 140 comprise center 142, left and right front 149 and 148, left and right rear surround 147 and 146, and low frequency effect 144 channel output connections. The speakers of the surround sound system 160 are preferably coupled to the audio output connections 140 as follows: a sub-woofer 179 coupled to the low frequency channel output 144 via link 169, left and right front speakers 171 and 173 coupled to the left and right front channel outputs 149 and 148 via links 161 and 163, left and right rear surround speakers 175 and 177 coupled to the left and right rear surround channel outputs 147 and 146 via links 165 and 167, and a center speaker 172 to the center channel output 142 via link 164.

In one embodiment, an amplifier 180 may be coupled to the system 160 interposing the audio channel speakers 171, 173, 175, 177 and the low frequency channel speaker 179 and the television 110 audio outputs 140. In another embodiment EIAJ optical link outputs may be used for digital connections to a digital class D full range amplifier—either mono or multi-channel. If mono the amplifier would allow daisy chaining of cable. Each amplifier could have a small switch for selecting which channel it is used for. E.g., using these high power modules that can take digital sound input directly. As a result, the audio will stay digital right to power amplifier in this way. The audio signal can either be compressed or uncompressed. Such power amplifier can either be embedded into the TV, embedded into each speaker or be an external box.

In operation, the user using a menu system provided in the control system software 126 can select available audio modes such as “television audio,” “2.0 stereo,” “3.1 stereo” or “surround sound” if the speakers for surround sound are connected to the audio outputs of the television. If “television audio” is selected, the control system software 126 will instruct the audio decoder/controller 118 to decode and output the audio signal from the current selected audio input source to the television speakers 132 and 134. If, however, “surround sound” is selected the control system software 126 will instruct the audio decoder/controller 118 to decode the audio signal from the current selected audio input source and output the audio channels to the appropriate audio output connections 140 to drive the speakers linked thereto. However, if, e.g., no left or right speakers are coupled to the left and right audio outputs of the television, the surround sound mode will utilize the television speakers 132 and 134. By measuring if a speaker is physically connected either through a switch in the connector itself or through measuring the impedance, it's possible to automate the setup process and ensure that only valid speaker modes are presented in the user interface.

Alternatively, the user can be prompted to select the separate center channel speaker 172 or the television speakers 132 and 134 are utilized in “surround sound” mode.

Turning to FIG. 5, another embodiment of the audio-video entertainment system 250 is shown to include a television 210 used to drive a surround sound system 260. The television 210 preferably does not include a center channel output connection and, thus, directs all center channel output to the television speakers 232 and 234 when in “surround sound” mode. As with one of the previous embodiments, the surround sound system 260 may include an audio amplifier 180 interposing the television 210 and the sub-woofer 179, the left and right front 171 and 173, and the left and right rear surround audio speakers 175 and 177.

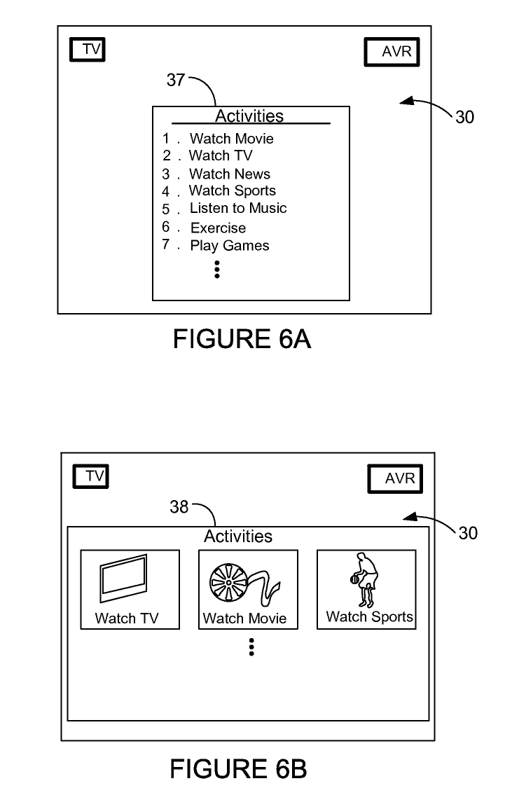

In another alternative embodiment, preferred sound mode settings can be saved to conform to different viewing experiences or activities. For example, activities such as “Watch News”, “Watch Movie”, “Watch Sports”, “Listen to Music”, “Play Games”, etc. Such viewing activities can be presented, as depicted in FIGS. 6A and 6B, in an activities menu 37 o 38 on the TV display screen 30 or on the remote control display screen, and when a particular activity is selected, the control system software will instruct the audio decoder/controller to decode and output the audio signal from the current selected audio source to the speakers corresponding to the sound mode setting selected for viewing activity. If “television audio” is selected for the viewing activity, the control system software will instruct the audio decoder/controller to decode and output the audio signal from the current selected audio source to the television speakers. If, however, “surround sound” is selected for the viewing activity the control system software will instruct the audio decoder/controller to decode the audio signal from the current selected audio input source and output the audio channels to the appropriate audio output connection.

Preferably, by selecting a particular activity the TV and connected device will automatically turn-on and implement preferred connections and settings for the activity selected. For example, if “Watch Movie” is selected, the followings actions will take place:

1. Blueray player is powered on;

2. TV is on and Blueray player is selected as input source;

3. Movie video settings are applied;

4. The system is switched to surround mode;

5. The volume is demuted.

In addition, in a further alternative embodiment, individual audio and video settings could be saved per each activity for optimized viewing and listening experience for a given activity. This feature is particular useful where a multi-mode device like a media center PC, Playstation 3, XBOX360 etc. is present and can be used to play a game, watch a movie, view photos, etc., and the user has a desire to setup the activity preferences different per device activity mode, i.e., “Play Game”, “Watch Movie”, etc. When the media center PC gets selected to play a 3D game (“Play Game” in activity menu), the TV preferably goes into it's 3D mode settings, if available. When the media center PC is used to playback a BluRay movie (“Watch Movie” activity menu), the TV implements its movie watching settings and disables the 3D settings in this instance. Thus, the user of a combination device providing gaming and movie capabilities (Playstation 3, XBOX360 and others) could have separate optimized audio and video settings for each activity “Play Game” and “Watch Movie”.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A process comprising the steps of
receiving instructions to proceed with a viewing activity selected by a user, wherein the selected viewing activity includes a sound mode setting of surround sound, and
outputting an audio signal from an audio center channel input connection to the television speakers.

2. The process of claim 1 further comprising the steps of prompting the user to select a viewing activity.

3. The process of claim 2 wherein the step of prompting the user to select a viewing activity includes presenting a list of viewing activities in a navigatable user interface on a display screen of the television.

4. The process of claim 3 wherein the list is in the form of graphical icons.

5. The process of claim 3 wherein the list of viewing activities include one or more of “watch movie”, “watch TV”, “watch news”, “watch sports”, and “play games”.

6. The process of claim 1 further comprising the steps of retrieving the sound mode settings corresponding to the viewing activity stored in memory in the television.

7. The process of claim 1 further comprising the steps of receiving the identity of the viewer that selected the viewing activity.

8. The process of claim 7 further comprising the step switching the sound mode setting to the sound mode setting corresponding to the viewer's preference for the selected viewing activity.

9. The process of claim 8 further comprising the steps of identifying the viewer that selected the viewing activities.

10. The process of claim 9 wherein the step of identifying the viewer includes comparing a viewer specific characteristic to viewer specific characteristics stored in memory.

11. The process of claim 10 wherein the viewer specific characteristic is a finger print.

12. A process comprising the steps of
receiving instructions to proceed with a viewing activity selected by a user, wherein the selected viewing activity includes a sound mode setting of surround sound, and
outputting the audio channels of an audio signal from the current selected audio input source to the appropriate audio output connections of a television to drive the speakers linked thereto.

13. The process of claim 1 further comprising the steps of prompting the user to select a viewing activity.

14. The process of claim 2 wherein the step of prompting the user to select a viewing activity includes presenting a list of viewing activities in a navigatable user interface on a display screen of the television.

15. The process of claim 3 wherein the list is in the form of graphical icons.

16. The process of claim 3 wherein the list of viewing activities include one or more of “watch movie”, “watch TV”, “watch news”, “watch sports”, and “play games”.

17. The process of claim 1 further comprising the steps of retrieving the sound mode settings corresponding to the viewing activity stored in memory in the television.

18. The process of claim 1 further comprising the steps of receiving the identity of the viewer that selected the viewing activity.

19. The process of claim 7 further comprising the step switching the sound mode setting to the sound mode setting corresponding to the viewer's preference for the selected viewing activity.

20. The process of claim 8 further comprising the steps of identifying the viewer that selected the viewing activity by comparing a viewer specific characteristic to viewer specific characteristics stored in memory.
